(19) United States
(12) Patent Application Publication
(10) Pub. No.: US 2017/0199157 A1
(43) Pub. Date: Jul. 13, 2017

(54) SUB-SURFACE NON-METALLIC INCLUSION DETECTION

(71) Applicant: Schaeffler Technologies AG & Co. KG, Herzogenaurach (DE)

(72) Inventors: Shawn Pierce, Fort Mill, SC (US); Melanie Mackert, Erlangen (DE); Wolfgang Liewald, Rock Hill, SC (US)

(73) Assignee: Schaeffler Technologies AG & Co. KG, Herzogenaurach (DE)

(21) Appl. No.: 15/399,979

(22) Filed: Jan. 6, 2017

Related U.S. Application Data
(60) Provisional application No. 62/276,011, filed on Jan. 7, 2016.

(51) Int. Cl. G01N 27/90; F16C 41/00

(52) U.S. Cl. CPC G01N 27/9033; G01N 27/9046; F16C 41/002; F16C 2204/60

(57) ABSTRACT

A fabricated sample of a bearing ring including sub-surface non-metallic inclusions, including a first bore and a second bore extending but not penetrating a bearing raceway surface, a non-metallic material inserted into the second bore and a first and a second plug for the first and the second hole, respectively. A method of fabricating a bearing detection sample including a sub-surface non-metallic inclusion and using the fabricated sample to detect sub-surface non-metallic inclusions in production parts, including fabricating the detections sample, tuning a suitable detection probe using the sample, and using the tuned and optimized probe to detect sub-surface non-metallic inclusions in production bearing components.

### FIELD

The invention relates generally to non-destructive detection of non-metallic inclusions in steel bearings, in particular, fabrication of a standard to simulate non-metallic inclusions.

### BACKGROUND

Non-metallic inclusions in steel are typically the result of contamination or chemical reactions during the steel refining or forming process and consist of non-metals or non-metallic compounds that are present in steels and alloys of steel. The presence of non-metallic inclusions in steel disrupts the homogeneity of the material and can negatively impact the mechanical properties of the material. For example, in bearings, non-metallic inclusions near the operating or running surface of bearing raceways can cause premature failure of the bearing. Non-destructive detection of non-metallic inclusions in bearing steel is needed.

### BRIEF SUMMARY

Example aspects broadly comprise a detection sample to simulate non-metallic inclusions in bearings, including a bearing ring including a first surface and a second raceway surface separated by a material thickness; at least one first perforation at a first depth into the first surface; at least one second perforation at a second depth extending from the first depth of the first perforation toward the second raceway surface; and a non-metallic material inserted into the second perforation, wherein the first depth and the second depth are less than the material thickness.

Example aspects broadly comprise a method of fabricating a standard to simulate sub-surface non-metallic inclusions in bearings including; drilling a first bore to a first depth into a first surface of a bearing ring opposite a raceway surface; drilling a second bore to a second depth in a bottom surface of the first bore; inserting a non-metallic material into the second bore; and, plugging the first and the second bores.

Other example aspects broadly comprise, a method of detecting sub-surface non-metallic inclusions in bearings including; fabricating a detection sample, tuning a detection probe to detect a sub-surface non-metallic inclusion in the detection sample; and detecting non-metallic inclusions in production bearing components.

### BRIEF DESCRIPTION OF THE DRAWINGS

The nature and mode of operation of the present invention will now be more fully described in the following detailed description taken with the accompanying drawing figures, in which:

FIG. 1 is a cross sectional view of a bearing ring according to an example aspect;

FIG. 2 is an expanded cross sectional view of portion Z of the bearing ring of FIG. 1;

FIG. 3 is a schematic view of a process to detect sub-surface non-metallic inclusions in bearings.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

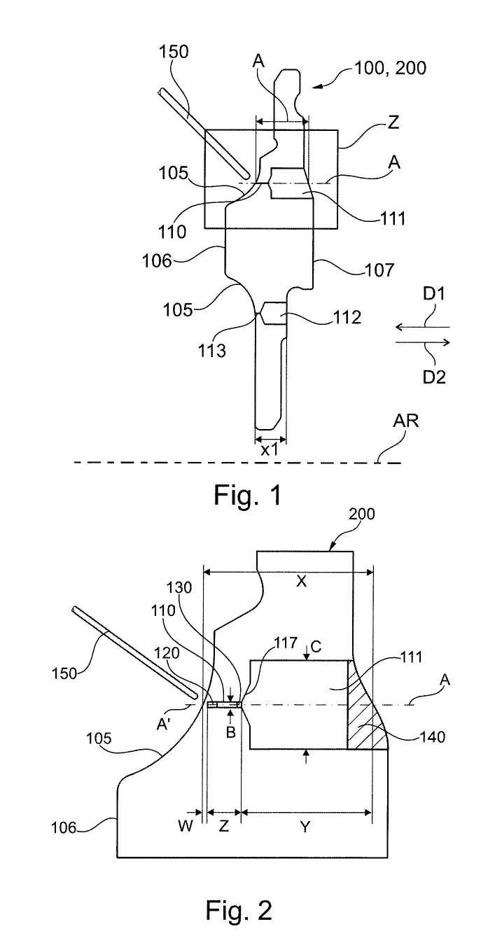

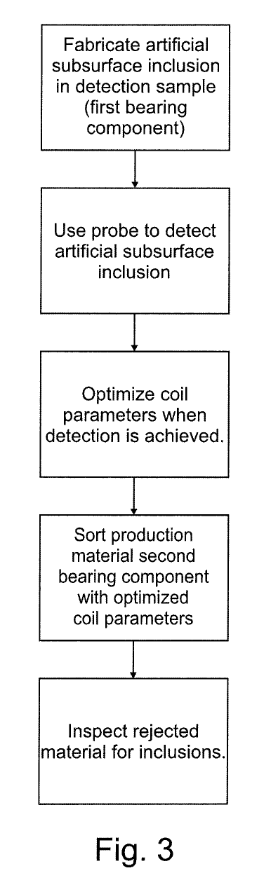

The following description is made with reference to FIGS. 1-3. FIG. 1 is a cross-sectional view of bearing ring 100. FIG. 2 is an expanded cross sectional view of portion Z of bearing ring 100 of FIG. 1. FIG. 3 is a schematic view of a process to detect sub-surface non-metallic inclusions in bearing rings.

Bearing ring 100, once modified as described below, is used as detection sample 200. Bearings and bearing rings are known in the art. The cross section shown of bearing ring 100 is of a double row ball bearing; however, one of ordinary skill in the art would understand that any bearing ring can be used. Bearing ring 100 includes: axis of rotation AR; raceway 105; raceway side or surface 106; side or surface 107; bore 110; and bore 111. Raceway 105 and surface 106 each face, at least partially, in direction D1. Surface 107 faces, at least partially, in direction D2, opposite direction D1. Raceway 105 and surface 107 are separated by material thickness x. Material thickness x, in the example embodiment of FIGS. 1 and 2, varies along the cross section of the bearing ring. Material thickness x discussed below is taken along axis A of perforation or bore 110. Perforation or bore 111 is larger in diameter than perforation or bore 110, and can, though not required to, have axis A′ coincident with axis A of perforation 110. In an example embodiment, bearing 100 includes bore 112 and bore 113 analogous to bores 111 and 110, respectively. Material thickness x1 is applicable to bores 112 and 113. If there are further bores, respective material thicknesses x2, x3 and so on are measured as needed. In an example embodiment, directions D1 and D2 are parallel to axis AR.

Bore or perforation 111 can be formed by any method known in the art; however, in the example embodiment of FIGS. 1 and 2, drilling is used. Bore or perforation 110 is then formed, in this example aspect, by drilling, through bottom surface 117 of bore 111, in direction D1 towards raceway 105, but, not through raceway 105. Surface 117 bounds bore 111 in direction D1. Perforation 111 has diameter C and depth y. Perforation 110 has diameter B and depth z. Diameter C can be equal to or greater than diameter B. In this example embodiment, diameter B is less than or equal to about 300 μm. In this example embodiment, a combined depth of depth y and depth z is less than material thickness x by at least depth w. In this example embodiment, depth w is less than or equal to about 200 μm.

Non-metallic material 120 is inserted into perforation 110. In this example embodiment, aluminum oxide is used as non-metallic material 120; however, other suitable non-metallic materials may be used. Perforation 110 is then plugged or sealed with plug 130, in this example embodiment, with wire plug 130. Perforation 111 is plugged or sealed, in this example embodiment, with suitable plug 140. Bearing ring 100 is made into a detection sample 200 in this manner.

Bearing ring detection sample 200 is then used to tune suitable probe 150 to detect artificially created sub-surface non-metallic inclusion 120. In this example embodiment, probe 150 is a suitable focused eddy current probe, however, other suitable probes may be used. The tuning of probe 150 includes utilizing low frequencies and small air gaps to optimize the detection of sub-surface non-metallic inclusion 120. In an example embodiment, the low frequencies range from 0.2 to 2.0 kHz and the air gap ranges from 0.2 to 2.0 mm.

A method of fabricating a detection sample or standard to simulate sub-surface non-metallic inclusions is now described. Hole or perforation 111 is formed, in the example aspect of FIGS. 1 and 2, by drilling, in direction D1, into bearing ring first surface 107 to depth y. Hole or perforation 110 is then formed, in this example aspect, by drilling, in direction D1, into bottom surface 117 of hole 111 towards bearing raceway surface 106 to a second depth z. The combination of depths y and z are less than depth x, leaving depth w between second hole 110 and raceway surface 106 of raceway 105. A non-metallic material 120, such as aluminum oxide, is inserted into second hole 110. Hole 110 is then plugged or sealed with a first plug 130 and hole 111 is then plugged with a second plug 140. In an example embodiment, depth y is more than about 200 μm from the surface of the bearing race. In the step of drilling the second hole the second depth, the second depth is less than or equal to about 200 μm. In the step of drilling the second hole the second hole diameter is no more than about 300 μm in diameter.

A method of detecting sub-surface non-metallic inclusions in bearings will now be described in reference to the schematic view of FIG. 3. First detection sample 200 is fabricated, as described above. A suitable probe 150 is applied and tuned, by optimizing coil parameters in an example embodiment of an eddy current probe, to detect artificially fabricated sub-surface non-metallic inclusion 120. The tuning of probe 150 includes utilizing low frequencies and small air gaps to optimize the detection of sub-surface non-metallic inclusion 120. In an example embodiment, the low frequencies range from 0.2 to 2.0 kHz and the air gap ranges from 0.2 to 2.0 mm. Once probe 150 is tuned to detect sub-surface non-metallic inclusion 120, probe 150 is used in manufacturing or production processes to detect sub-surface non-metallic inclusions and sort product parts. Parts rejected for sub-surface non-metallic inclusions would then be inspected in an off-production line material laboratory or inspection process.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A detection sample to simulate non-metallic inclusions in bearings, comprising:
a bearing ring including:
a first surface facing at least partially in a first direction; and;
a raceway surface facing at least partially in a second direction, opposite the first direction;
a first perforation:
extending a first depth, in the second direction and toward the raceway surface, into the first surface, the first perforation including a bottom surface bounding the first perforation in the second direction;
a second perforation, in the bottom surface of the first perforation, the second perforation extending in the second direction and toward the raceway surface to a second depth; and,
a non metallic material disposed in the second perforation;
wherein the second perforation does not extend to the raceway surface.

2. The detection sample of claim 1, wherein the second perforation is less than about 200 μm from the raceway surface.

3. The detection sample of claim 1, wherein the non-metallic material is aluminum oxide.

4. The detection sample of claim 1, further comprising a first plug for the first perforation and a second plug for the second perforation.

5. The detection sample of claim 1, wherein the second perforation has a diameter no greater than about 300 μm.

6. A method of fabricating a standard to simulate sub-surface non-metallic inclusions in a bearing, comprising:
drilling, in a first direction and into a first surface of the bearing, a first bore to a first depth;
drilling, in the first direction and into a bottom surface of the first bore, a second bore to a second depth, the bottom surface bounding the first bore in the first direction;
inserting a non-metallic material into the second bore; and,
plugging the first and second bores.

7. The method of claim 6, wherein:
the first surfaces faces, at least partially, in a second direction, opposite the first direction;
the bearing includes a raceway surface facing, at least partially, in the first direction; and,
drilling the first bore includes drilling the first bore so that the first bore is more than about 200 μm from the raceway surface.

8. The method of claim 6, wherein:
the first surfaces faces, at least partially, in a second direction, opposite the first direction;
the bearing includes a raceway surface facing, at least partially, in the first direction; and,
drilling the second bore includes drilling the second bore so that the second bore is less than about 200 μm from the raceway surface.

9. The method of claim 6, wherein inserting the non-metallic material into the second bore includes inserting aluminum oxide into the second bore.

10. The method of claim 6, wherein drilling the second bore includes drilling a diameter for the second bore of less than about 300 μm.

11. The method of claim 6, wherein:
the bearing includes an axis of rotation; and,
the first direction is parallel to the axis of rotation.

12. The method of claim 6, wherein:
the first bore has a longitudinal axis;
the second bore has a longitudinal axis; and,
the longitudinal axis for the first and second bores are co-linear.

13. The method of claim 6, wherein:
the first bore has a longitudinal axis;
the second bore has a longitudinal axis; and,
the longitudinal axis for the first and second bores are not co-linear.

14. A method of detecting sub-surface non-metallic inclusions in a bearing, comprising:
drilling, in a first direction and into a first surface of a first bearing component, a first bore to a first depth;
drilling, in the first direction and into a bottom surface of the first bore, a second bore to a second depth, the bottom surface bounding the first bore in the first direction;
inserting a non-metallic material into the second bore;
plugging the first and second bores;
tuning a detection probe to detect the non-metallic material in the first bearing component;
detecting, with the tuned detection probe, a non-metallic inclusion in a second bearing component.

15. The method of claim 13, wherein tuning the detection probe includes tuning an eddy current detection probe.

16. The method of claim 13, wherein tuning the detection probe includes using low frequencies and small air gaps.
